(19) United States
(12) Patent Application Publication
(10) Pub. No.: US 2020/0019567 A1
(43) Pub. Date: Jan. 16, 2020

(54) Analytics Platform for Streaming Media and Methods Thereof

(71) Applicant: Jabberwocky Publishing LLC, Los Angeles, CA (US)

(72) Inventor: Kevin Marques Moo, Los Angeles, CA (US)

(21) Appl. No.: 16/507,394

(22) Filed: Jul. 10, 2019

Related U.S. Application Data
(60) Provisional application No. 62/696,282, filed on Jul. 10, 2018.

(51) Int. Cl. G06F 16/687; H04L 29/06; G06F 16/68; G06F 17/22; G06F 16/64; G06N 20/20

(52) U.S. Cl. CPC G06F 16/687; H04L 65/4069; G06N 20/20; G06F 17/227; G06F 16/64; G06F 16/686

(57) ABSTRACT

Disclosed herein is an analytics platform for streaming media including, in some embodiments, an application-programming-interface (“API”) client, a data-processing framework, and a reporting API. The API client is configured to request and receive both streaming-media metadata and user data from one or more digital service providers (“DSPs”). The data-processing framework is configured to process the metadata and the user data to yield processed data. The reporting API is configured to provide the processed data, data analysis of the metadata, the user data, or the processed data, or both the processed data and the data analysis to one or more content partners upon request respectively by one or more content-partner API clients.

### PRIORITY

This application claims the benefit of and priority to U.S. Provisional Patent Application No. 62/696,282, filed Jul. 10, 2018, which is incorporated by reference in its entirety into this application.

### BACKGROUND

For decades, the primary metric utilized in the recorded music business has been revenue per unit (“RPU”), omnipresent on royalty and sales reports. RPU worked when the recorded music business was based on physical sales of music media (e.g., phonograph records, compact audio cassettes, compact discs, etc.) and even digital sales of downloadable music files. Today, the recorded music business no longer adheres to an ownership model. It is now an access model. Therefore, the metrics of the recorded music business need a reimaging, especially in light of the big datasets now provided by digital service providers (“DSPs”). Provided herein is an analytics platform for streaming media and methods thereof that address the foregoing need.

### SUMMARY

Disclosed herein is an analytics platform for streaming media including, in some embodiments, an API client, a data-processing framework, and a reporting API. The API client is configured to request and receive both streaming-media metadata and user data from one or more DSPs. The data-processing framework is configured to process the metadata and the user data to yield processed data. The reporting API is configured to provide the processed data, data analysis of the metadata, the user data, or the processed data, or both the processed data and the data analysis to one or more content partners upon request respectively by one or more content-partner API clients.

In some embodiments, the analytics platform further includes master reference data providing permissible values for the metadata and the user data including uncommon streaming-media metadata from certain DSPs.

In some embodiments, the analytics platform further includes one or more machine-learning models and one or more machine-learning algorithms. The one or more machine-learning algorithms are configured for training the one or more machine-learning models with the metadata, the user data, the processed data, or a combination thereof. At least some of the data analysis includes predictions by the machine-learning models for queries not present in the metadata, the user data, or the processed data.

In some embodiments, the predictions include identification of future trends by geolocation in accordance with propensity modeling.

In some embodiments, the one or more machine-learning algorithms includes SMOTE.

In some embodiments, the streaming media is digital music.

In some embodiments, the data-processing framework is configured to separate out the metadata for each listen of a digital-music file including method-of-discovery metadata for the digital-music file and listen-through metadata for the digital music file down to a second.

In some embodiments, the data-processing framework is configured to correlate geolocation with population demographics to measure interest-group density in each market.

In some embodiments, the reporting API is configured to provide to the one or more content-partner API clients the data analysis as selected from stream counts per digital-music file, combined stream counts by global region and subdivisions, listenership by market, average streams per listener, and active listeners.

In some embodiments, the reporting API is configured to service requests made to a URI for any of a number of resources with a response in a stateless protocol selected from XML, HTML, or JSON.

Also disclosed herein is non-transitory machine-readable medium having stored thereon a set of instructions that cause an analytics platform for streaming media to perform one or more operations when the instructions are executed by one or more processors of the analytics platform. The one or more operations include requesting and receiving with an API client both streaming-media metadata and user data from one or more DSPs; processing the metadata and the user data with a data-processing framework to yield processed data; and providing the processed data, data analysis of the metadata, the user data, or the processed data, or both the processed data and the data analysis with a reporting API to one or more content partners upon request respectively by one or more content-partner API clients.

In some embodiments, the set of instructions on the machine-readable medium cause the analytics platform to perform the one more operations further including providing by way of a master reference data permissible values for the metadata and the user data including uncommon streaming-media metadata from certain DSPs.

In some embodiments, the set of instructions on the machine-readable medium cause the analytics platform to perform the one more operations further including training one or more machine-learning models with one or more machine-learning algorithms on the metadata, the user data, the processed data, or a combination thereof; and making predictions for queries not present in the metadata, the user data, or the processed data and including the predictions as at least some of the data analysis.

In some embodiments, the set of instructions on the machine-readable medium cause the analytics platform to perform the one more operations further including identifying future trends by geolocation in accordance with propensity modeling; and providing the future trends in with the predictions.

In some embodiments, the set of instructions on the machine-readable medium cause the analytics platform to perform the one more operations further including incorporating SMOTE in the one or more machine-learning algorithms.

In some embodiments, the set of instructions on the machine-readable medium cause the analytics platform to perform the one more operations further including processing the metadata and the user data of digital music as the streaming media.

In some embodiments, the set of instructions on the machine-readable medium cause the analytics platform to perform the one more operations further including separating out the metadata for each listen of a digital-music file using the data-processing framework. The metadata separated out by the data-processing framework includes method-of-discovery metadata for the digital-music file and listen-through metadata for the digital-music file down to a second.

In some embodiments, the set of instructions on the machine-readable medium cause the analytics platform to perform the one more operations further including measuring interest-group density in each market by correlating geolocation and population demographics with the data-processing framework.

In some embodiments, the set of instructions on the machine-readable medium cause the analytics platform to perform the one more operations further including providing to the one or more content-partner API clients with the reporting API the data analysis selected from stream counts per digital-music file, combined stream counts by global region and subdivisions, listenership by market, average streams per listener, and active listeners.

In some embodiments, the set of instructions on the machine-readable medium cause the analytics platform to perform the one more operations further including servicing requests made to a URI for any of a number of resources of the reporting API with a response in a stateless protocol selected from XML, HTML, or JSON.

These and other features of the concepts provided herein will become more apparent to those of skill in the art in view of the accompanying drawings and following description, which disclose particular embodiments of such concepts in greater detail.

### DRAWINGS

FIG. 1 illustrates a digital media aggregator in relation to a number of content providers and digital service providers in accordance with some embodiments.

FIG. 2 illustrates an analytics platform of a digital media aggregator in electronic communication with a number of content providers and digital service providers in accordance with some embodiments.

FIG. 3 provides a network host such as any one or more server hosts of the analytics platform in accordance with some embodiments

FIG. 4 illustrates training a machine-learning model and predicting with a trained machine-learning model in accordance with some embodiments.

FIG. 5 shows a screen of a dashboard in a graphical user interface of a tablet computer, wherein the dashboard includes market data for a number of listeners of a number of digital service providers, in accordance with some embodiments.

FIG. 6A shows a screen of a dashboard in a graphical user interface of a smartphone, wherein the dashboard includes device-type data for a number of listeners of a number of digital service providers, in accordance with some embodiments.

FIG. 6B shows a screen of a dashboard in a graphical user interface of a smartphone, wherein the dashboard includes operating system-identification data for a number of listeners of a number of digital service providers, in accordance with some embodiments.

FIG. 6C shows a screen of a dashboard in a graphical user interface of a smartphone, wherein the dashboard includes gender data for a number of listeners of a number of digital service providers, in accordance with some embodiments.

FIG. 6D shows a screen of a dashboard in a graphical user interface of a smartphone, wherein the dashboard includes age data for a number of listeners of a number of digital service providers, in accordance with some embodiments.

FIG. 6E shows a screen of a dashboard in a graphical user interface of a smartphone, wherein the dashboard includes song-stream data for a number of listeners of a number of digital service providers, in accordance with some embodiments.

FIGS. 6F and 6G show a screen of a dashboard in a graphical user interface of a smartphone, wherein the dashboard includes market data for a number of listeners of a number of digital service providers, in accordance with some embodiments.

FIG. 6H shows a screen of a dashboard in a graphical user interface of a smartphone, wherein the dashboard includes listener data for a number of listeners of a number of digital service providers, in accordance with some embodiments.

FIG. 6I shows a screen of a dashboard in a graphical user interface of a smartphone, wherein the dashboard includes listener data for a particular listener of a particular digital service providers, in accordance with some embodiments.

FIG. 6J shows a screen of a dashboard in a graphical user interface of a smartphone, wherein the dashboard includes consumption data for a number of listeners of a number of digital service providers, in accordance with some embodiments.

FIG. 6K shows a screen of a dashboard in a graphical user interface of a smartphone, wherein the dashboard includes consumption-driver data for a number of listeners of a number of digital service providers, in accordance with some embodiments.

FIG. 6L shows a screen of a dashboard in a graphical user interface of a smartphone, wherein the dashboard includes market-share data for a number of digital service providers, in accordance with some embodiments.

FIG. 6M shows a first screen of a feed of insights in a graphical user interface of a smartphone in accordance with some embodiments.

FIG. 6N shows a second screen of a feed of insights in a graphical user interface of a smartphone in accordance with some embodiments.

FIG. 6O shows a third screen of a feed of insights in a graphical user interface of a smartphone in accordance with some embodiments.

FIG. 6P shows a fourth screen of a feed of insights in a graphical user interface of a smartphone in accordance with some embodiments.

FIG. 6Q shows a fifth screen of a feed of insights in a graphical user interface of a smartphone in accordance with some embodiments.

FIG. 7 shows a method of an analytics platform in accordance with some embodiments.

### DESCRIPTION

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “front,” “back,” “top,” “bottom,” and the like are used for convenience and are not intended to imply, for example, any particular fixed location, orientation, or direction. Instead, such labels are used to reflect, for example, relative location, orientation, or directions. Singular forms of“a,” “an,” and “the” include plural references unless the context clearly dictates otherwise.

Abbreviations, initialisms, acronyms, or the like used herein include, but are not limited to, revenue per unit (“RPU”), digital service provider (“DSP”), application programming interface (“API”), Synthetic Minority Over-sampling TEchnique (“SMOTE”), AutoRegressive Integrated Moving Average (“ARIMA”), Seasonal Trend decomposition using Loess (“STL”), uniform resource identifier (“URI”), eXtensible Markup Language (“XML”), HyperText Markup Language (“HTML”), and JavaScript Object Notation (“JSON”).

Unless defined otherwise, all technical and scientific terms used herein have the same meaning as commonly understood by those of ordinary skill in the art.

Again, the RPU metric worked when the music business was based on physical sales of music media (e.g., phonograph records, compact audio cassettes, compact discs, etc.) and even digital sales of downloadable music files. However, the music business no longer adheres to an ownership model but to an access model. Therefore, the metrics of the music business need a reimaging, especially in light of the big datasets now provided by DSPs. Provided herein is an analytics platform for streaming media and methods thereof that address the foregoing need.

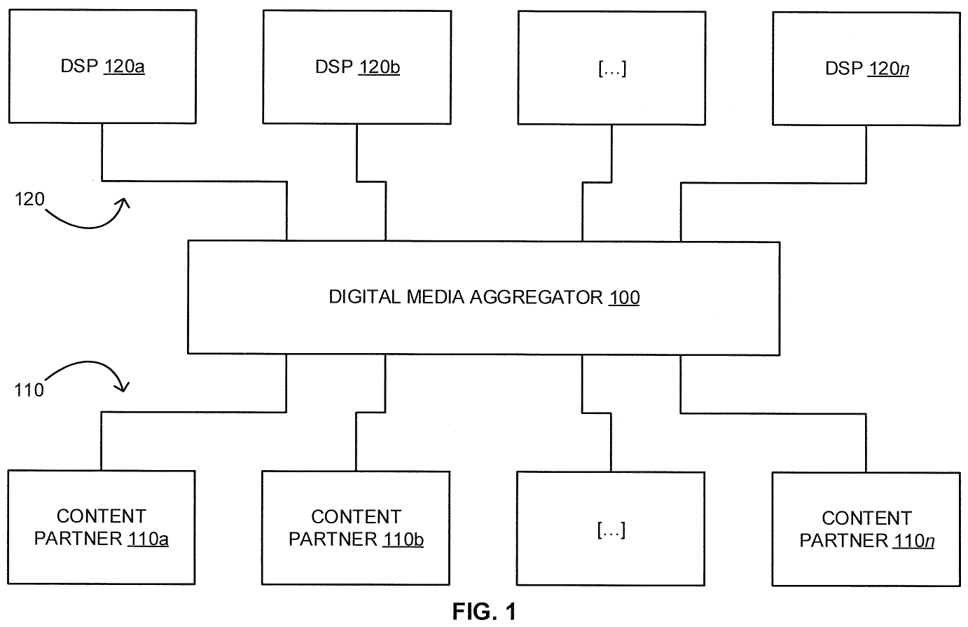

FIG. 1 illustrates a digital media aggregator 100 in relation to a number of content partners 110 and digital service providers 120 in accordance with some embodiments.

The digital media aggregator 100 can be a digital music aggregator, the content partners 110 can be digital music partners (e.g., record companies), and the digital service providers 120 can be digital music providers (e.g., Spotify, Apple Music, Google Play, etc.). In such embodiments, the digital music aggregator can aggregate digital music from the digital music partners and provide the digital music to the digital music providers for streaming to listeners subscribed to the digital music providers.

Digital music is but one type of digital media and, in turn, digital media is but one type of digital content. While embodiments set forth herein are primarily described with reference to digital media such as digital music, it should be understood that any type of digital content can be aggregated for distribution to digital service providers 120 configured to provide the digital content. Furthermore, metadata and user data related to use of the digital content can be processed by the analytics platform set forth herein. As such, at least financial services, energy, insurance, advertising, health, social media, and manufacturing can benefit from the analytics platform.

### Analytics Platform

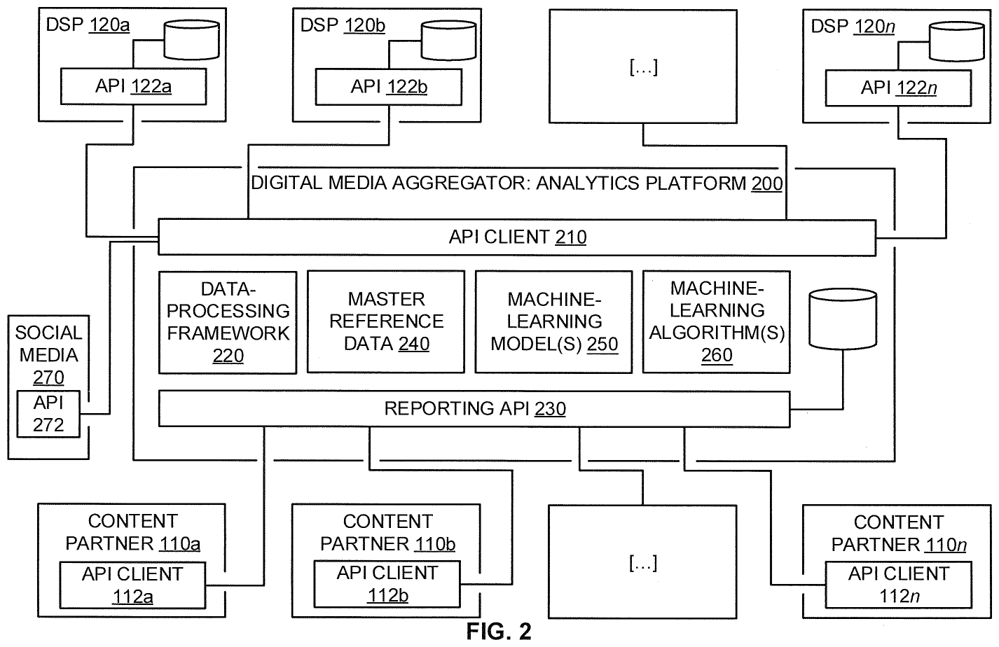

FIG. 2 illustrates an analytics platform 200 of the digital media aggregator 100 in electronic communication with the number of content partners 110 and the digital service providers 120, or platforms thereof, in accordance with some embodiments.

As shown in FIG. 2, the analytics platform 200 includes, in some embodiments, an API client 210, a data-processing framework 220, and a reporting API 230. The analytics platform 200 can be configured for streaming media. In such embodiments, the API client 210 is configured to request and receive both streaming-media metadata and user data from one or more DSPs 120 (e.g., DSP 120a, DSP 120b, . . . , DSP 120n) by way of one or more DSP APIs 122 (e.g., DSP API 122a, DSP API 122b, . . . , DSP API 122n). The data-processing framework 220 is configured to process the metadata and the user data to yield processed data. The reporting API 230 is configured to provide i) the processed data, ii) data analysis of the metadata, the user data, or the processed data, iii) or both the processed data and the data analysis to one or more content partners 110 (e.g., content partner 110a, content partner 110b, . . . , content partner 110n) upon request respectively by one or more content-partner API clients 112 (e.g., content-partner API client 112a, content-partner API client 112b, . . . , content-partner API client 112n).

As further shown in FIG. 2, the analytics platform 200 further includes, in some embodiments, master reference data 240. The master reference data 240 provides permissible values for the metadata and the user data including uncommon streaming-media metadata from certain types of digital media or DSPs. For example, when the streaming media is digital music, certain types of digital music such as classical music have uncommon streaming-media metadata compared to digital music such as popular music.

Further with respect to streaming media such as digital music, the data-processing framework 220 is configured to separate out the metadata for each listen of a digital-music file including method-of-discovery metadata for the digital-music file and listen-through metadata for the digital music file down to a second. The data-processing framework 220 is configured to do such processing for billions of music files streamed per day. The data-processing framework 220 is further configured to correlate geolocation with population demographics to measure interest-group density in each market.

The reporting API 230 is configured to service requests made to a URI for any of a number of resources with a response in a stateless protocol selected from XML, HTML, or JSON. The reporting API 230 is configured to provide to the one or more content-partner API clients 112 making the requests the data analysis as selected from at least stream counts per digital-music file, combined stream counts by global region and subdivisions, listenership by market, average streams per listener, and active listeners.

In this way, the data analysis provided by the analytics platform 200 to the one or more content partners enable the content partners to identify audiences, audience locations, and identify strategies to grow such audiences once located, and predict where such audiences will next develop.

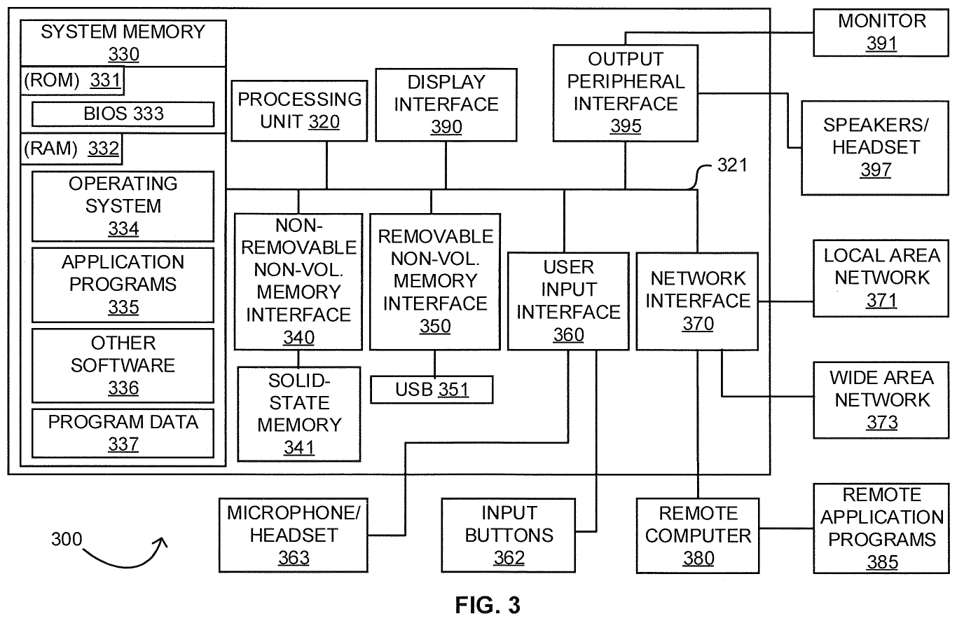

FIG. 3 provides a network host 300 such as any one or more server hosts of the analytics platform 200 in accordance with some embodiments.

Components of the network host 300 can vary in accordance with host type. For example, any one or more server hosts exemplified by the network host 300 can be configured differently to support machine learning, a web server, an application server, a database server, an e-mail server, etc. As such, each and every component shown and described in reference to FIG. 3 need not be included in each host type. Furthermore, each host type can further include components not shown or described in reference to FIG. 3 but otherwise described or alluded to herein.

As shown, components of the network host 300 can include, but are not limited to, a processing unit 320 having one or more processing cores, a primary or system memory 330, and a system bus 321 configured to couple various system components including the system memory 330 to the processing unit 320. The system bus 321 can be any of several types of bus structures selected from a memory bus or memory controller, a peripheral bus, and a local bus using any of a variety of bus architectures.

The network host 300 can include a variety of machine-readable media. Machine-readable media can be any media that can be accessed by the network host 300 and includes both volatile and nonvolatile media, as well as removable and non-removable media. By way of example, and not limitation, use of machine-readable media includes storage of information, such as machine-readable instructions, data structures, other executable software, or other data. Machine-readable media includes, but is not limited to, random-access memory (“RAM”), read-only memory (“ROM”), electrically erasable programmable read-only memory (“EEPROM”), flash memory or other memory technology, CD-ROM, digital versatile disks (“DVD”) or other optical disk storage, magnetic cassettes, magnetic tape, magnetic disk storage or other magnetic storage devices, or any other tangible medium that can be used to store the desired information for access by the network host 300. Communication media typically embody machine-readable instructions, data structures, other executable software, or other transport mechanisms and includes any information delivery media. As an example, some client hosts on a network might not have optical or magnetic storage.

The system memory 330 includes machine-readable media in the form of volatile or nonvolatile memory such as ROM 331 and RAM 332. A basic input-output system (“BIOS”) 333 containing the basic routines that help to transfer information between elements within the network host 300, such as during start-up, is typically stored in ROM 331. RAM 332 typically contains software or data that are immediately accessible for operations by the processing unit 320. By way of example, and not limitation, FIG. 3 illustrates that RAM 332 can include a portion of the operating system 334, application programs 335, other executable software 336, and program data 337.

The network host 300 can also include other machine-readable media. By way of example only, FIG. 3 illustrates a solid-state memory 341. Other machine-readable media that can be used in the example operating environment include, but are not limited to, universal serial bus (“USB”) drives and devices, flash memory cards, solid state RAM, solid state ROM, or the like. The solid-state memory 341 is typically connected to the system bus 321 through a non-removable memory interface such as interface 340, and USB drive 351 is typically connected to the system bus 321 by a removable memory interface such as interface 350.

The drives and their associated machine-readable media provide storage of machine-readable instructions, data structures, other executable software, or other data for the network host 300.

A user can enter commands and information into the network host 300 through input devices such as a keyboard, touchscreen, or software or hardware input buttons 362, a microphone 363, a pointing device such as a mouse, or scrolling input component such as a trackball or touch pad. The microphone 363 can cooperate with speech recognition software. These and other input devices are often connected to the processing unit 320 through a user input interface 360 that is coupled to the system bus 321 but can be connected by other interface and bus structures, such as a parallel port, game port, or USB. A display monitor 391 or other type of display screen device is also connected to the system bus 321 via an interface such as a display interface 390. In addition to the monitor 391, the network host 300 can also include other peripheral output devices such as speakers 397, and other output devices, which can be connected through an output peripheral interface 395.

The network host 300 can operate in a networked environment using logical connections to one or more other network hosts such as remote computer 380. Like the network host 300, the network host 380 can be any one or more server hosts of the analytics platform 200 in accordance with some embodiments. That said, the network host 380 can alternatively be a host of the number of content partners 110, a host of the digital service providers 120, or a mobile client such as a tablet computer or smartphone. The logical connections depicted in FIG. 3 can include a local area network (“LAN”) 371 (e.g., Wi-Fi) and a wide area network (“WAN”) 373 (e.g., Internet), but can also include other enterprise-wide machine networks, intranets, or the like.

When used in a LAN networking environment, the network host 300 is connected to the LAN 371 through a network interface or adapter 370, which can be, for example, an Ethernet adapter or Wi-Fi adapter. When used in a WAN networking environment (e.g., Internet), the network host 300 can include some means for establishing communications over the WAN 373 such as the Ethernet adapter. With respect to telecommunication technologies, for example, a radio interface, which can be internal or external, can be connected to the system bus 321 via the network interface 370, or another appropriate mechanism. In a networked environment, other software depicted relative to the network host 300, or portions thereof, can be stored in the remote memory storage device. By way of example, and not limitation, FIG. 3 illustrates remote application programs 385 as residing on the network host 380. It will be appreciated that the network connections shown are examples and other means of establishing a communications link between the network hosts can be used.

In some embodiments, software used to facilitate algorithms discussed herein can be embodied into a non-transitory machine-readable medium (e.g., a non-transitory computer-readable medium). A machine-readable medium includes any mechanism that stores information in a form readable by a machine such as the network host 300. For example, a non-transitory machine-readable medium can include ROM; RAM; magnetic disk storage media; optical storage media; flash memory devices; DVDs, EPROMs, EEPROMs, FLASH memory, magnetic or optical cards, or any type of media suitable for storing electronic instructions.

An application described herein includes, but is not limited to, software applications and programs that are part of an operating system or integrated with or on an application layer thereof. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C+, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a network host, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry.

### Machine Learning

As further shown in FIG. 2, the analytics platform 200 further includes, in some embodiments, one or more machine-learning models 250 and one or more machine-learning algorithms 260.

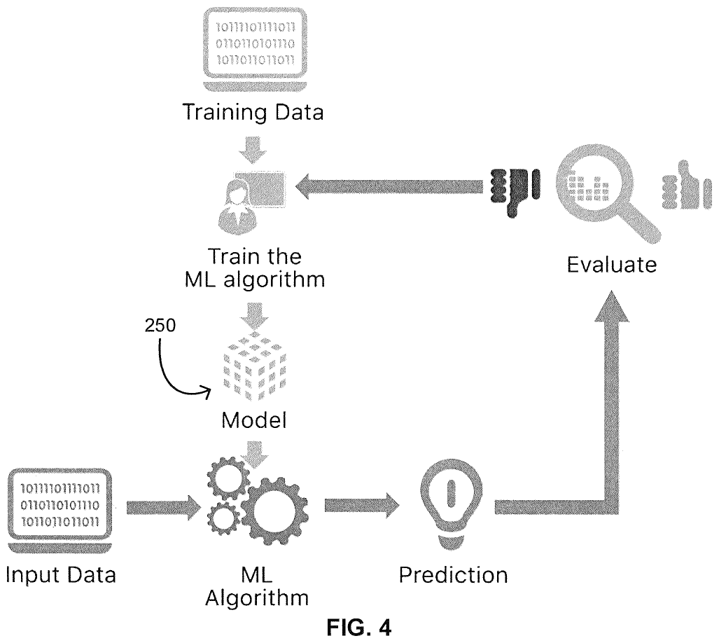

FIG. 4 illustrates training at least one of the machine-learning models 250 and predicting with a trained machine-learning model in accordance with some embodiments.

As shown in FIG. 4, at least one of the one or more machine-learning algorithms 260 is configured for training at least one of the one or more machine-learning models 250 with the metadata, the user data, the processed data, or a combination thereof. The one or more machine-learning algorithms 260 can include SMOTE, Holt Linear, Holt-Winters, ARIMA, Seasonal ARIMA, or STL for training the one or more machine-learning models 250 for time-series forecasting. At least some of the data analysis provided by the reporting API 230 includes predictions by the machine-learning model for queries not present in the metadata, the user data, or the processed data. The predictions include identification of future trends by geolocation in accordance with propensity modeling.

Equation 1 for mean absolute error (“mae”) is an important equation in the quest for accurate predictions by propensity modeling with respect to, for example, streams of digital music files:

$$mae = \frac{1}{n} {\sum }_{i = 1}^{n} \vert {y}_{i} - {x}_{i} \vert \qquad Equation 1$$

In equation 1, n=the number of observations in a dataset (in days), i=the index of summation (integer of 1), x=the predicted stream count, and y=the actual stream count. As such, the summation of the sequence is an expression whose value is the sum of each of the members of the sequence.

The one or more machine-learning models 250 can also be trained with one or more additional machine-learning algorithms to analyze social media sentiment from social media 270 (e.g., Facebook, Instagram, Twitter, etc.) platforms by way of a social-media API 272 as shown in FIG. 2; identify “converted” listeners (e.g., people who listen to a specific artist on more than 3 different days over a 30 days span), as well as identify “die hard” listeners (e.g., people who listen to a specific artist on more than 10 different days over a 30 days span), which allows for subsequent calculation of conversion rates for listeners; calculate listener engagement in accordance with an average stream count per unique listener; or determine daily listener growth.

### Graphical User Interfaces

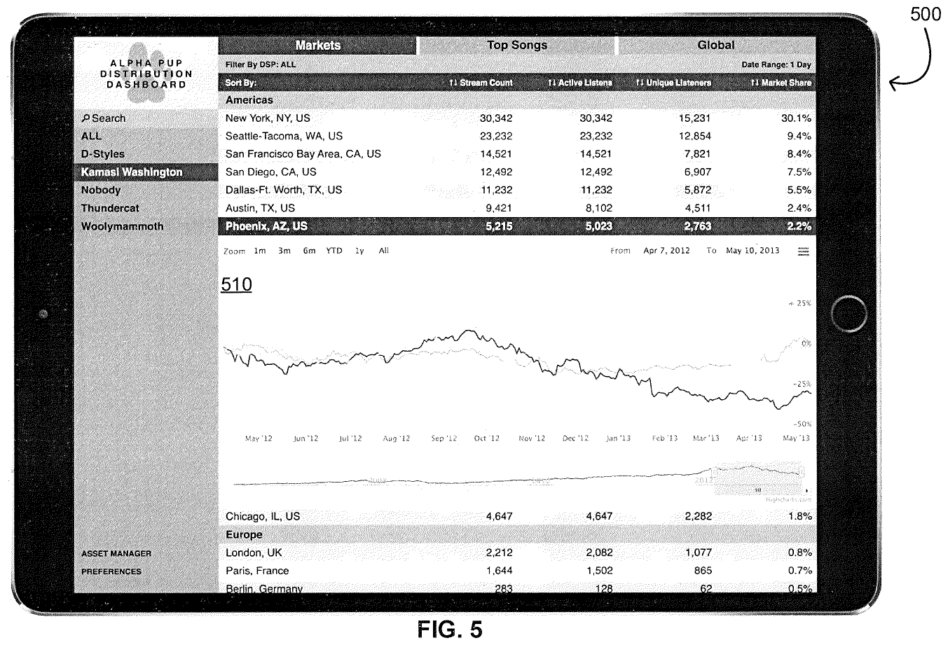

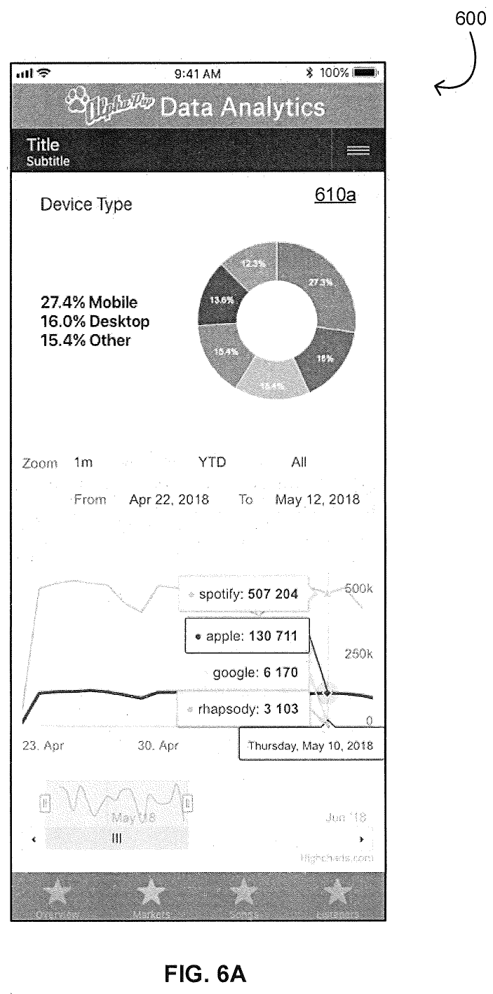

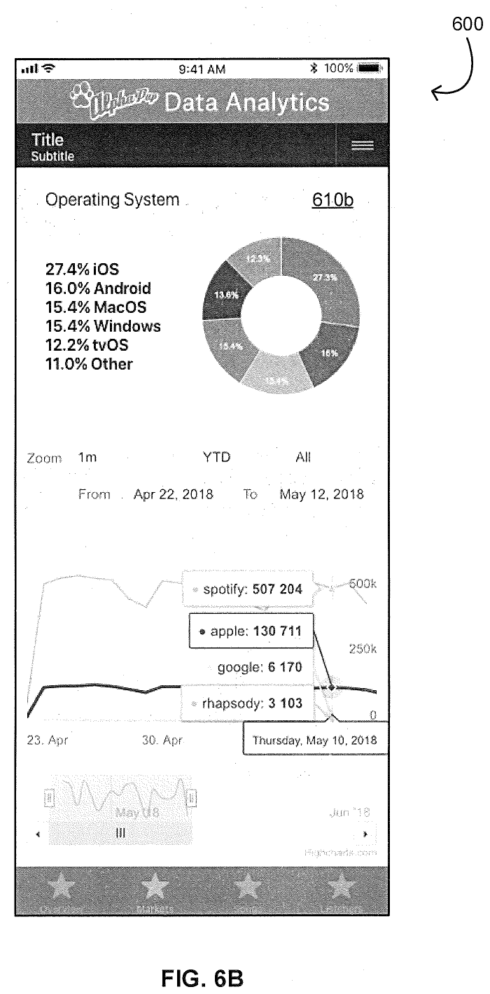

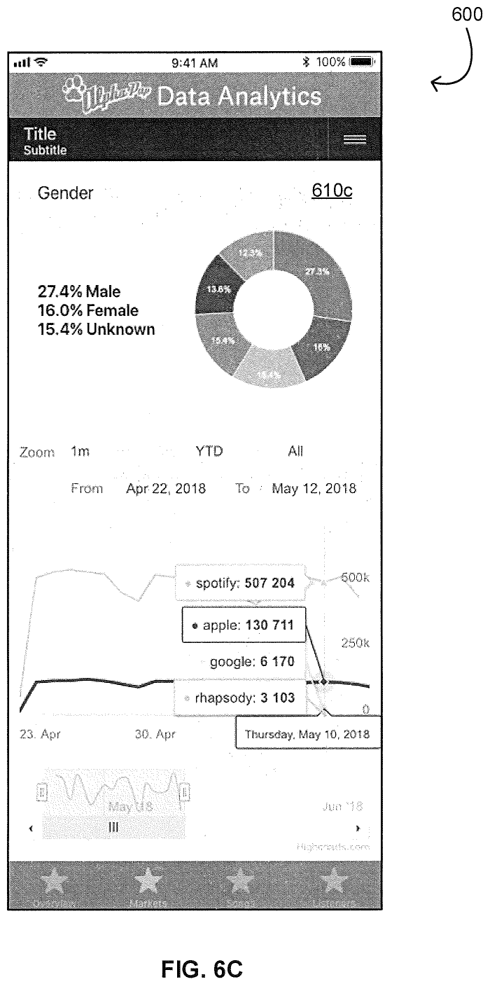

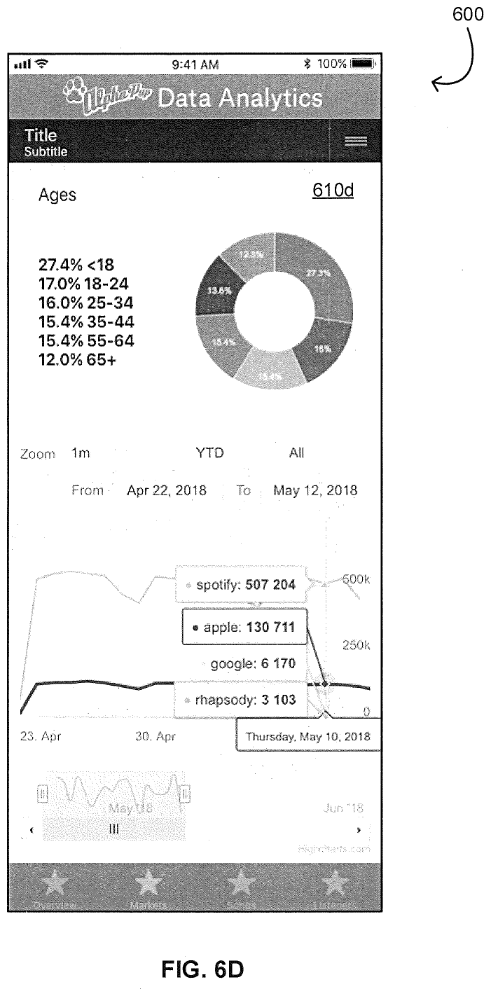

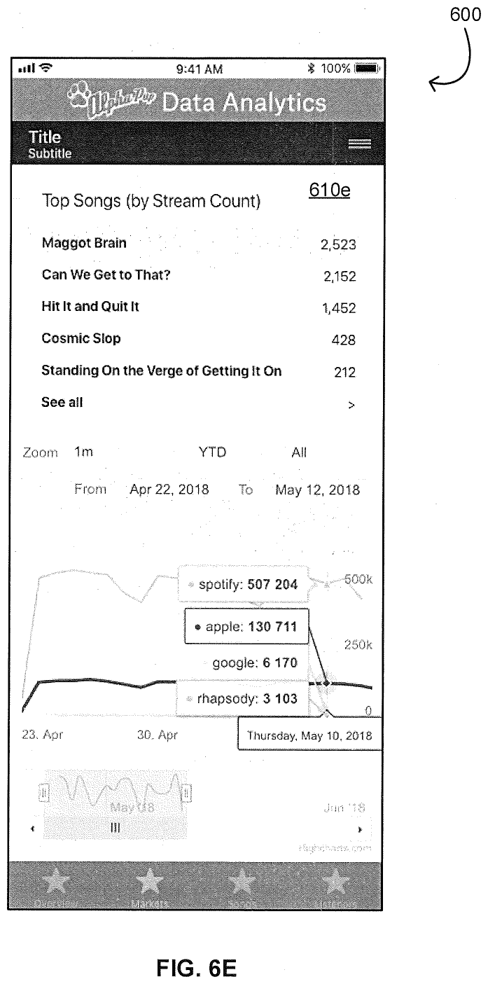

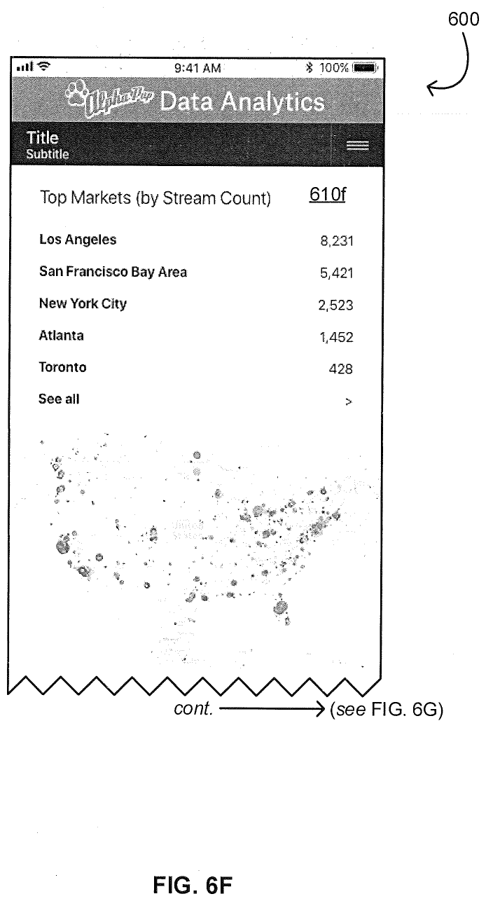

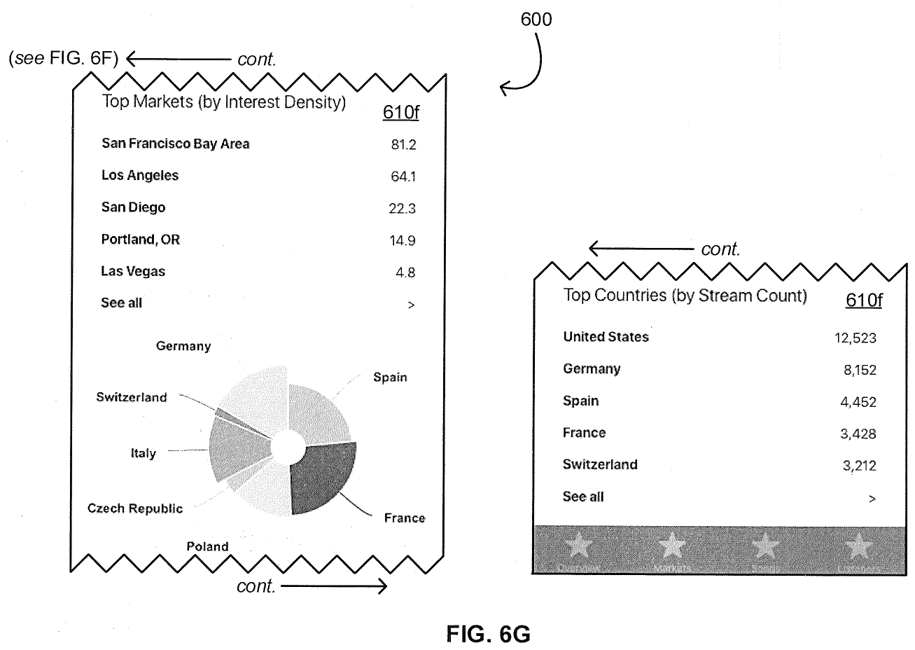

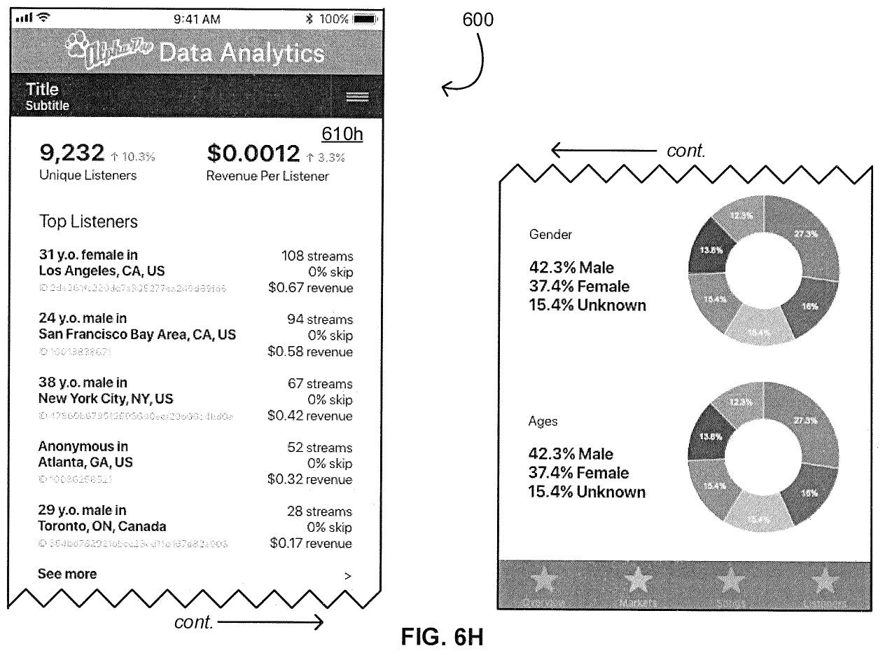

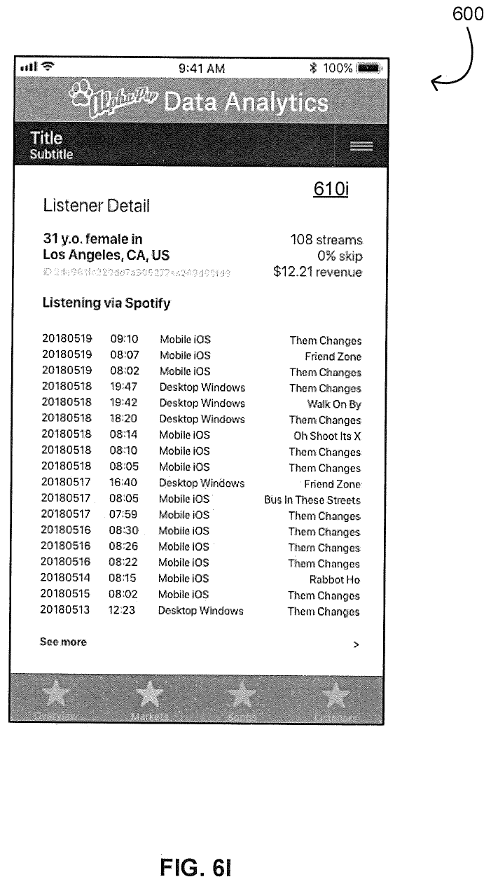

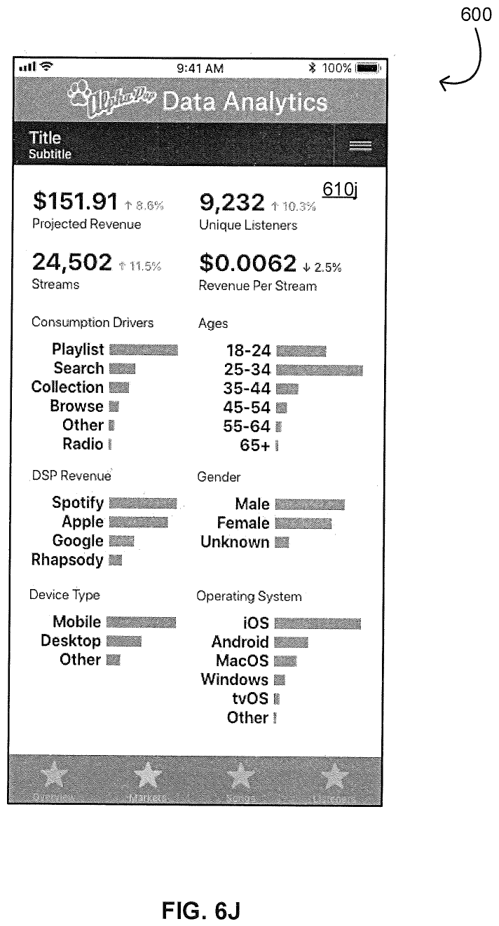

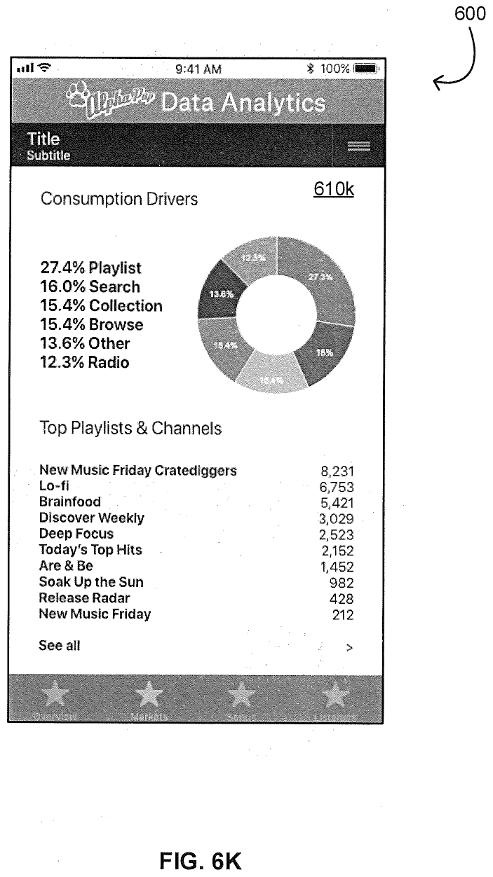

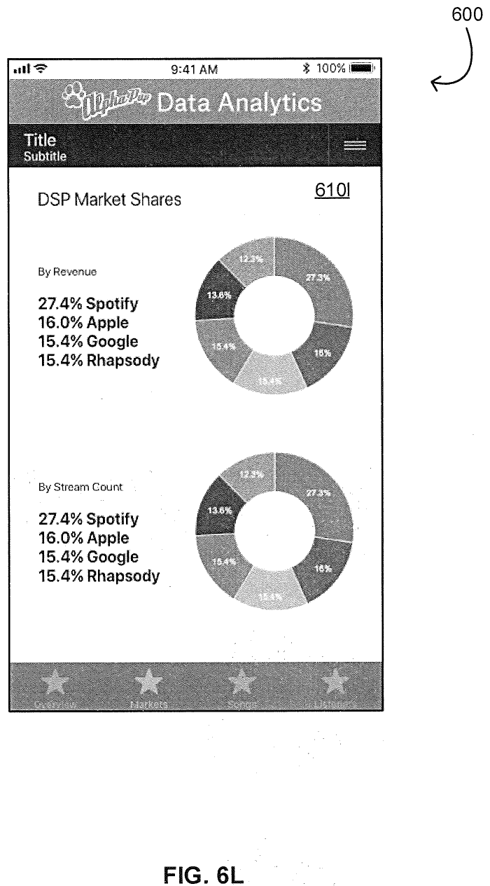

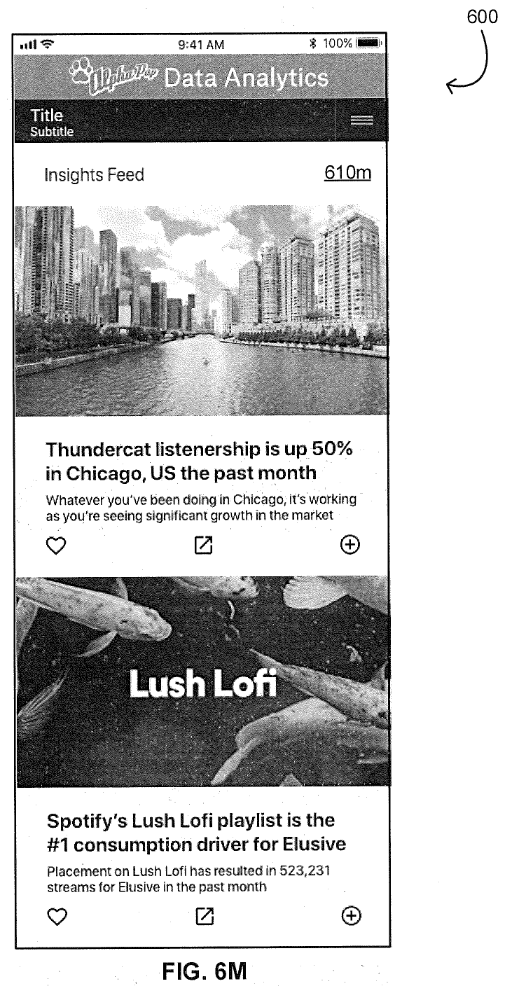

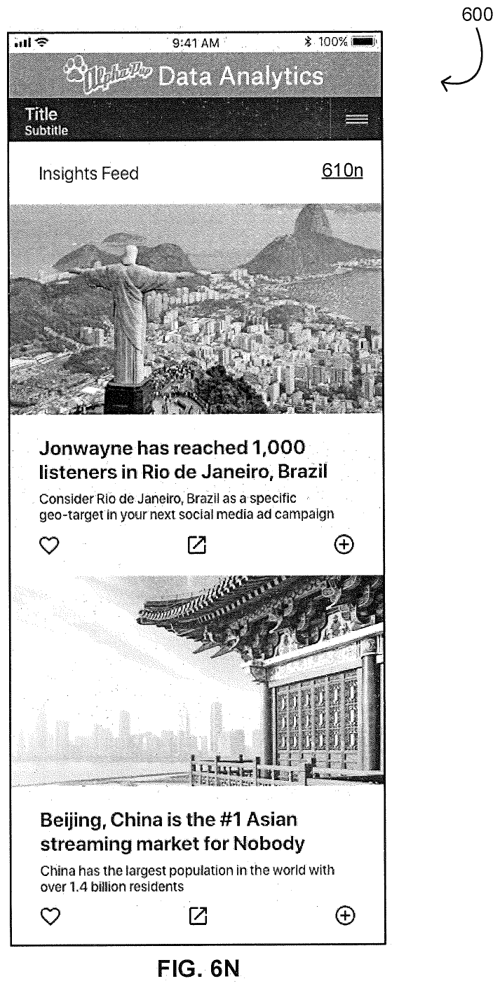

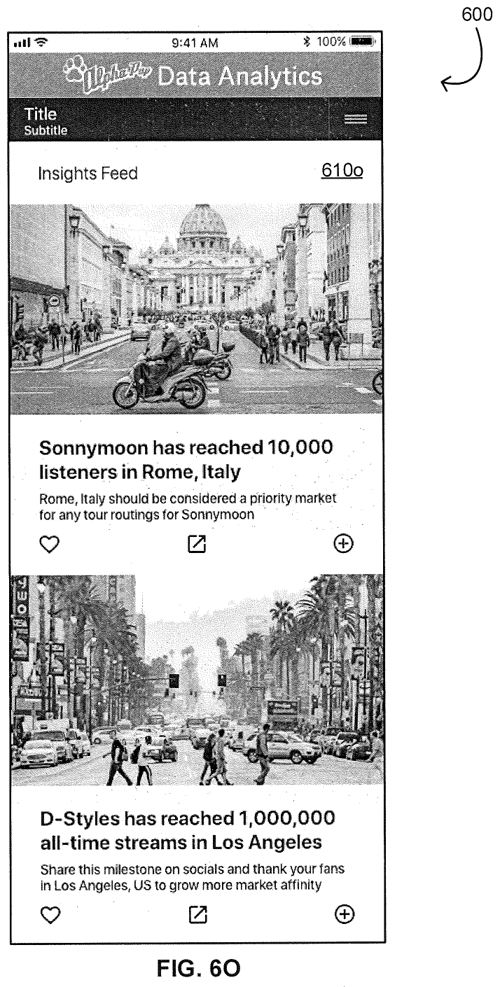

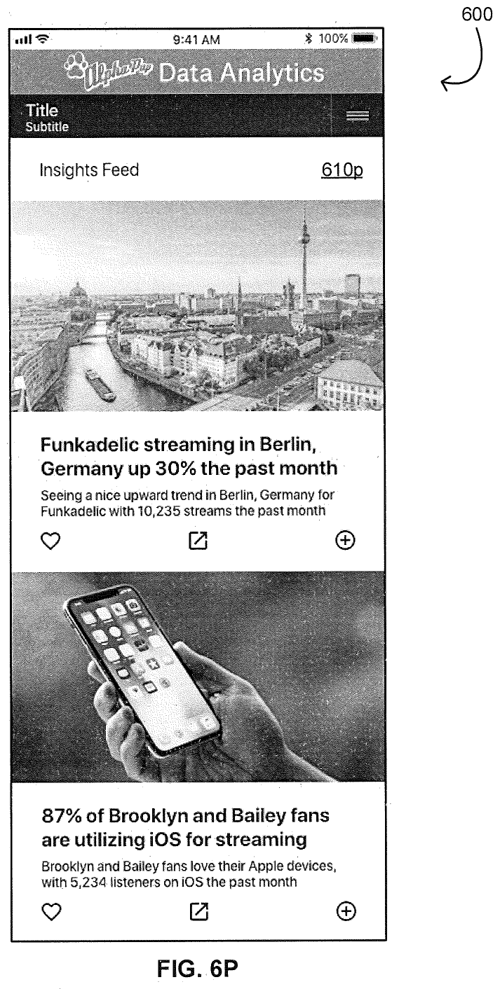

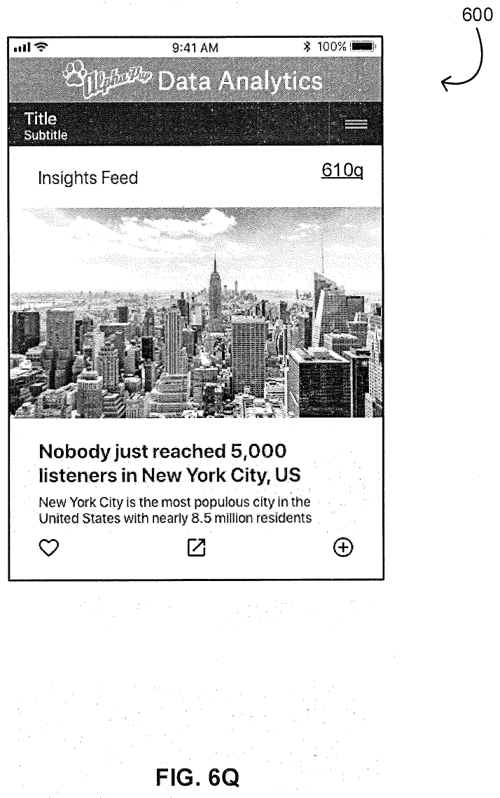

FIG. 5 shows a screen 510 of a dashboard in a graphical user interface of a tablet computer 500, wherein the dashboard includes market data for a number of listeners of a number of digital service providers 120, in accordance with some embodiments. FIGS. 6A-6Q show various screens 610a-610f and 610h-610q of a dashboard in a graphical user interface of a smartphone 600, wherein the various screens 610a-610f and 610h-610q of the dashboard include data for a number of listeners of a number of digital service providers 120, in accordance with some embodiments. Such data can include percentages or ordinal and intervallic scale milestones across a number of dimensions of a dataset, generating an “infinitely” scrollable feed with as few as 200 streams per day over the course of 30 days of data input. Such data, which can also include predictions by the one or more machine-learning models 250, when adequately trained, can be provided to a mobile app or a mobile web app configured to receive the data such as through the reporting API 230 of the analytics platform 200.

### Methods of Operating the Analytics Platform

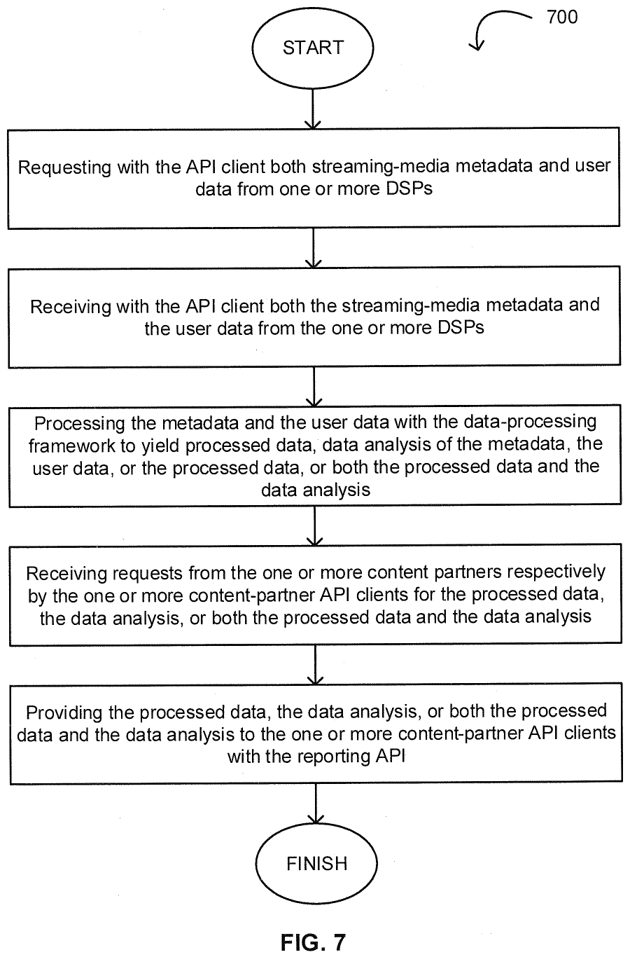

FIG. 7 shows a method 700 of an analytics platform 200 in accordance with some embodiments.

A non-transitory machine-readable medium can have a set of instructions stored thereon that cause the analytics platform 200 such as that of FIG. 2 to perform one or more operations of the method 700 when the instructions are executed by one or more processors or processing units 320 of the analytics platform 200. As shown in FIG. 7, the one or more operations include, but are not limited to, requesting and receiving with the API client 210 both streaming-media metadata and user data from one or more DSPs; processing the metadata and the user data with the data-processing framework 220 to yield processed data; and providing the processed data, data analysis of the metadata, the user data, or the processed data, or both the processed data and the data analysis with the reporting API 230 to one or more content partners upon request respectively by the one or more content-partner API clients 112.

Following on the method 700 shown in FIG. 7, the one more operations can further include providing by way of the master reference data 240 permissible values for the metadata and the user data including uncommon streaming-media metadata from certain DSPs.

The one more operations can further include training the one or more machine-learning models 250 with the one or more machine-learning algorithms 260 on the metadata, the user data, the processed data, or a combination thereof; and making predictions for queries not present in the metadata, the user data, or the processed data. The predictions can be included as at least some of the data analysis. Training the one or more machine-learning models 250 with the one or more machine-learning algorithms 260 can include incorporating SMOTE, Holt Linear, Holt-Winters, ARIMA, Seasonal ARIMA, or STL in the one or more machine-learning algorithms 260. In addition, making the predictions can include identifying future trends by geolocation in accordance with propensity modeling, as well as measuring interest-group density in each market by correlating geolocation and population demographics with the data-processing framework 220.

When the processing the metadata and the user data for digital music as the streaming media, the one more operations can further include separating out the metadata for each listen of a digital-music file using the data-processing framework 220. The metadata separated out by the data-processing framework 220 includes method-of-discovery metadata for the digital-music file and listen-through metadata for the digital-music file down to a second.

The one more operations further include servicing requests made to any of a number of URIs for corresponding resources of the reporting API 230 with responses in one or more stateless protocols selected from XML, HTML, and JSON. The data analysis selected from stream counts per digital-music file, combined stream counts by global region and subdivisions, listenership by market, average streams per listener, and active listeners can be provided to the one or more content-partner API clients 112 in at least one of the stateless protocols with the reporting API 230.

While some particular embodiments have been disclosed herein, and while the particular embodiments have been disclosed in some detail, it is not the intention for the particular embodiments to limit the scope of the concepts provided herein. Additional adaptations and/or modifications can appear to those of ordinary skill in the art, and, in broader aspects, these adaptations and/or modifications are encompassed as well. Accordingly, departures may be made from the particular embodiments disclosed herein without departing from the scope of the concepts provided herein.

What is claimed is:

1. An analytics platform for streaming media, comprising:
an application-programming-interface (“API”) client configured to request and receive both streaming-media metadata and user data from one or more digital service providers (“DSPs”);
a data-processing framework configured to process the metadata and the user data to yield processed data; and
a reporting API configured to provide the processed data, data analysis of the metadata, the user data, or the processed data, or both the processed data and the data analysis to one or more content partners upon request respectively by one or more content-partner API clients.

2. The analytics platform of claim 1, further comprising master reference data providing permissible values for the metadata and the user data including uncommon streaming-media metadata from certain DSPs.

3. The analytics platform of claim 1, further comprising one or more machine-learning models and one or more machine-learning algorithms to train the one or more machine-learning models with the metadata, the user data, the processed data, or a combination thereof, wherein at least some of the data analysis includes predictions by the machine-learning models for queries not present in the metadata, the user data, or the processed data.

4. The analytics platform of claim 3, wherein the predictions include identification of future trends by geolocation in accordance with propensity modeling.

5. The analytics platform of claim 3, wherein the one or more machine-learning algorithms includes Synthetic Minority Over-sampling Technique (“SMOTE”).

6. The analytics platform of claim 1, wherein the streaming media is digital music.

7. The analytics platform of claim 6, wherein the data-processing framework is configured to separate out the metadata for each listen of a digital-music file including method-of-discovery metadata for the digital-music file and listen-through metadata for the digital music file down to a second.

8. The analytics platform of claim 6, wherein the data-processing framework is configured to correlate geolocation with population demographics to measure interest-group density in each market.

9. The analytics platform of claim 6, wherein the reporting API is configured to provide to the one or more content-partner API clients the data analysis as selected from stream counts per digital-music file, combined stream counts by global region and subdivisions, listenership by market, average streams per listener, and active listeners.

10. The analytics platform of claim 6, wherein the reporting API is configured to service requests made to a uniform resource identifier (“URI”) for any of a number of resources with a response in a stateless protocol selected from eXtensible Markup Language (“XML”), HyperText Markup Language (“HTML”), or JavaScript Object Notation (“JSON”).

11. A non-transitory machine-readable medium having stored thereon a set of instructions that cause an analytics platform for streaming media to perform one or more operations when the instructions are executed by one or more processors of the analytics platform, the one or more operations comprising:
requesting and receiving with an application-programming-interface (“API”) client both streaming-media metadata and user data from one or more digital service providers (“DSPs”);
processing the metadata and the user data with a data-processing framework to yield processed data; and
providing the processed data, data analysis of the metadata, the user data, or the processed data, or both the processed data and the data analysis with a reporting API to one or more content partners upon request respectively by one or more content-partner API clients.

12. The machine-readable medium of claim 11, wherein the set of instructions cause the analytics platform to perform the one more operations further comprising: providing by way of a master reference data permissible values for the metadata and the user data including uncommon streaming-media metadata from certain DSPs.

13. The machine-readable medium of claim 11, wherein the set of instructions cause the analytics platform to perform the one more operations further comprising training one or more machine-learning models with one or more machine-learning algorithms on the metadata, the user data, the processed data, or a combination thereof; and making predictions for queries not present in the metadata, the user data, or the processed data and including the predictions as at least some of the data analysis.

14. The machine-readable medium of claim 13, wherein the set of instructions cause the analytics platform to perform the one more operations further comprising identifying future trends by geolocation in accordance with propensity modeling; and providing the future trends in with the predictions.

15. The machine-readable medium of claim 13, wherein the set of instructions cause the analytics platform to perform the one more operations further comprising including Synthetic Minority Over-sampling Technique (“SMOTE”) in the one or more machine-learning algorithms.

16. The machine-readable medium of claim 11, wherein the set of instructions cause the analytics platform to perform the one more operations further comprising processing the metadata and the user data of digital music as the streaming media.

17. The machine-readable medium of claim 16, wherein the set of instructions cause the analytics platform to perform the one more operations further comprising separating out the metadata for each listen of a digital-music file using the data-processing framework, wherein the metadata separated out by the data-processing framework includes method-of-discovery metadata for the digital-music file and listen-through metadata for the digital-music file down to a second.

18. The machine-readable medium of claim 16, wherein the set of instructions cause the analytics platform to perform the one more operations further comprising measuring interest-group density in each market by correlating geolocation and population demographics with the data-processing framework.

19. The machine-readable medium of claim 16, wherein the set of instructions cause the analytics platform to perform the one more operations further comprising providing to the one or more content-partner API clients with the reporting API the data analysis selected from stream counts per digital-music file, combined stream counts by global region and subdivisions, listenership by market, average streams per listener, and active listeners.

20. The machine-readable medium of claim 16, wherein the set of instructions cause the analytics platform to perform the one more operations further comprising servicing requests made to a uniform resource identifier (“URI”) for any of a number of resources of the reporting API with a response in a stateless protocol selected from eXtensible Markup Language (“XML”), HyperText Markup Language (“HTML”), or JavaScript Object Notation (“JSON”).
